(19) United States
(12) Patent Application Publication
(10) Pub. No.: US 2010/0287775 A1
(43) Pub. Date: Nov. 18, 2010

(54) METHOD AND DEVICE FOR PRODUCING HELICAL SCREENS

(76) Inventors: Wolfgang Bachmann, Otzberg (DE); Marcel Julien, Rodermark (DE); Pascal Julien, Rodgau (DE)

Correspondence Address: FULBRIGHT & JAWORSKI, LLP, 666 FIFTH AVE, NEW YORK, NY, 10103-3198, US

(21) Appl. No.: 12/740,707

(22) PCT Filed: Oct. 22, 2008
(86) PCT No.: PCT/EP2008/008901

§ 371 Date: Jul. 19, 2010

(30) Foreign Application Priority Data
Nov. 3, 2007 (DE) 10 2007 052 594.1

(51) Int. Cl. B23P 15/16; B21F 45/00

(52) U.S. Cl. 29/896.61; 140/71 C

(57) ABSTRACT

A method and a device for producing helical screens by winding wires made of plastic into individual spirals, which are inserted into each other in an overlapping way in the transversal direction on a working surface and are united parallel to each other into permeable sheet materials by fixing wires. In order to achieve the task to provide a method and a device with which screen belts with spirals and fixing wires can be produced with low personnel, energy and investments costs (equipment costs) and low amounts of waste with high precision and reproducibility with low time effort, the invention proposes for the spirals to be deposited on winding devices by means of moveable joining devices next to each other on the work surface after winding and to be engaged on said work surface by transverse displacements and connected to each other by the fixing wires.

The invention relates to a method for the production of helical or coil screens by winding wires of synthetic material into individual coils which are slid one into the other on a working surface, such that they overlap in the transverse direction and are combined by fixing wires parallel to one another to form porous areal formations, wherein, after the winding, the coils are deposited one next to the other on the working surface and on this working surface are brought into engagement by a joining means and are connected with one another using the fixing wires.

Such coil screens, technically also referred to as spiral screens, have been produced since approximately 1970 and have been applied inter alia as liners or drier screens in paper machines. Further application fields are transport belts and slurry dewatering filters.

EP 0 017 722 A1 and the corresponding U.S. Pat. No. 4,346,138 disclose sieve belts and method for their production, in which a coil is generated through a winding means with a rotating and oscillating cone with connected mandrel. The windings have a spacing in order for them to be combined with other coils. Each of these coils is thermoset and deposited separately in one collection container which rotates synchronously with the winding means such that entanglements cannot occur. The further processing of the coils by sliding them laterally into other coils and the sliding of fixing wires into them takes place on separate machines.

A publication of LEO Feinwerktechnik GmbH & Co. KG, Dietzenbach (DE) by the title “Fügemaschine AS-60” describes drawing 60 separately prefabricated coils from 60 storage and transport containers located on a transport cart and connecting them with one another on this joining machine using 59 fixing wires. One half of the coils had herein been generated with right-hand rotation and the other half with left-hand rotation, which were connected with one another in alternating sequence. The known arrangement includes a bench with a working surface and a stand with 60 monofilament coils with fixing wires and a cutting device.

The principle of a winding device is disclosed in (laid-open) application DE-AS 1 956 321.

DE 35 45 805 A1 discloses two controversial paths for the production of planar formations of coiled synthetic monofilaments. On the one hand, the introduction of DE 35 45 805 A1 describes using a winding machine to produce coils with high pitch, e.g., having large winding spacings, for so-called spiral element assemblies and without intermediate storage to supply these coils subsequently directly to a joining device. However, this document does not discuss the positioning of these coils or any further details. On the other hand, in the continuation of the disclosure there is a discussion that a method with intermediate storage in containers is to be preferred; however, that in the case of large prefabricated winding spacings this method leads to knotting of the coils in the intermediate containers, which cannot be disentangled. The disclosure subsequently recommends intermediate storage in several cylindrical containers, however without large winding spacings, and these are subsequently only generated on the way toward the joining device by heating, elongation and cooling. The joining means, denoted here as a guide, in all implementation examples is stationarily disposed and includes up to eight channels, which approach one another at an acute angle and unite to form a channel of twofold width. Subsequently, from maximally eight coils, belt-like joined structures of limited length and width are produced by insertion of fixing wires. These joined structures can subsequently be combined with one another by utilizing further fixing wires. However, with a stationary joining means it is not possible to produce continuously screen and filter belts which have a virtually indefinite width or length. Such additional joining devices, however, are not disclosed in this document.

The known production methods and devices are complex and expensive. For the working bench alone at least one operator is required. A further shortcoming of the production with separate aggregates is the large fraction of scrap material accumulating at every production station. It is herein mandatory that the coils fabricated on the winding machines are absolutely set throughout, to be stress-free and dimensionally accurate since, for reasons of production techniques, at least a portion of the coils must be stored for several days in the storage containers before the coils arrive at the joining bench for further processing. The consequences are correspondingly high initial investments.

The invention, in contrast, addresses the problem of specifying a method and an arrangement with which, in spite of large dimensions, screen belts of coils and fixing wires can be produced with low personnel, energy and investment costs as well as low scrap accumulation with high precision and reproducibility at low time expenditure.

The posed problem is resolved in the above specified method according to the invention thereby that

a) the coils are generated by the at least one winding means above the working surface and, after thermal forming operation, through a movement of the joining means are deposited next to a guide rail on the working surface,

b) each of the succeeding coils, through a movement of its winding means and the joining means succeeding it, is deposited between the guide rail and the previously deposited coil on the working surface, wherein the at least one previously deposited coil through the movement of the joining means is displaced on the working surface transversely to this [joining means] by a measure of the overlap, and that

c) the particular last deposited coils are connected with one another through at least one inserted fixing wire.

Therewith the posed problem is resolved to its full extent thereby that screen belts with coils and fixing wires can be produced at low personnel, energy and investment costs as well as low time expenditure and scrap with high precision and reproducibility and large dimensions. A continuous series of linked operating steps can be combined in a single machine, which has considerably lesser weight and for which a single operator and considerably lesser footprint is entirely sufficient. Running about, interim transports, intermediate storage and the time- and energy-dependent changes entailed therein of the microgeometry of the coils no longer occur.

Material requirement and recycling of scrap are reduced. The potential scrap is reduced to approximately one third of the material utilized. This means a considerable production cost reduction at identical and even better quality. Individual components such as the known heavy winding machines with a weight of, for example, 500 kg, and a separate footprint of approximately 2 m² can be reduced to a miniature format above the working surface with a weight of less than 5 kg.

In the course of further embodiments of the method according to the invention it is especially advantageous if, either singly or in combination:

the particular coil is guided through an S-shaped guide channel through the guide means, whose upper end is oriented toward the winding means and whose lower end is oriented in the shape of an arc toward the working surface,
over the same working surface several winding means with guide means are moved spatially offset,

in addition to the fixing wires, filler wires are slid into the already combined coils,
the coils are produced by winding wires onto forming bodies whose cross section decreases in the direction of transport of the coils, and that the forming body is guided through a hot air stream in which the coiled wire is transformed into a stress-free state,
following the hot air treatment, the coil is cooled to a temperature below softening temperature,
the course of the path of the coils between winding means and joining means is acquired by a sensor means, and if discrepancies from a predetermined path course are transmitted to a driving motor to the effect that the movement speed of the winding means and of the joining means over the working surface is adapted to the joining process and/or if the areal formation on the working surface during passage through a heating apparatus is smoothed and brought to a predetermined thickness and is set through cooling.

The invention also relates to an arrangement for the production of coil screens with at least one winding device, through which wires or filaments of synthetic material are formable into individual coils, and with a working surface on which the coils can be deposited and with at least one joining device through which the coils can be slid one into the other and be combined through fixing wires parallel to one another to form porous areal formations.

To solve the same problem and with the same advantages, such an arrangement is characterized thereby that

a) the joining device is disposed such that it is displaceable over the working surface,

b) the at least one winding device is disposed above the working surface such that the coils after the winding can be deposited one next to the other on the working surface and, after their transverse displacement through the joining device, can be connected with one another through the fixing wires.

In the course of further embodiments of the arrangement according to the invention it is especially advantageous if, either singly or in combination:

a) above a working surface at least one winding device for the coils is disposed and on the working surface a guide rail for depositing and orienting the coils,

b) the joining device succeeds the winding device such that a further coil can be deposited by the joining device on the working surface between the guide rail and the previously deposited coil, and if

c) with the working surface is associated a slide-in device for inserting a fixing wire into the two particular last deposited coils,

the joining device includes an S-shaped guide channel whose upper end is oriented toward the winding device and whose lower end is oriented in the form of an arc toward the working surface,
associated with the working surface is a slide-in device for inserting a filler wire into at least one of the coils,

above the same working surface are disposed spatially offset several winding devices with joining devices such that they are movable,
for the production of the coils by winding wires, forming bodies are provided whose cross section decreases in the direction of transport of the coil, and that the forming body is encompassed by a heating chamber through which a hot air stream can be guided,

the joining device is disposed succeeding the winding device, wherein

a) the joining device is movable along the guide rail,

b) the joining device includes an underside and at least one side face in which is disposed a guide channel for the coil, through which the coil can be guided past the underside, and wherein

c) beneath the underside a guide profile is disposed of such height which corresponds to the height dimension H of the coil, wherein the guide profile is implemented in the form of a wedge such that the particular previously deposited coil(s) is(are) are displaceable so far in the transverse direction away from the guide rail that the newly supplied coil can be brought into overlapping engagement with the previously deposited coil,
the underside extends parallel to the working surface and said side face parallel to the guide rail,

for the formation and the draw-off of the coil the axes of winding device and forming body are oriented in the direction toward the joining device at an acute angle between 15 and 60 degrees to the working surface,

the winding device is preceded by a braking device for the supplied wire or filament,

for the acquisition of the path course of the coil between the winding device and the joining device a sensor device is disposed, through which discrepancies from a predetermined path course can be acquired and so transmitted to a driving motor that the movement rate of the winding device and of the joining device above the working surface can be adapted to the joining process,

on the working surface a heating apparatus is disposed, through which the areal formation during its passage can be smoothed and be brought to a predeterminable thickness,

if several winding devices are provided, these are disposed on separate carriages which, independently of one another, are disposed on a guide frame above the working surface and are movable over the working surface through one sensor device each for the path course of the coil, a regulation system and the associated driving motor,

the driving motors for moving the winding device are connected via pinions with a common toothed rack disposed on the guide frame,

associated with the winding devices is a further carriage which is connected via a gearing motor and a pinion with a further toothed rack, which [rack] is also disposed on the guide frame, and that the carriage bears at least one supply drum for the wire to be coiled, and/or, if

the carriage with the at least one supply drum can be regulated such that it tracks at a spacing the at least one associated winding device.

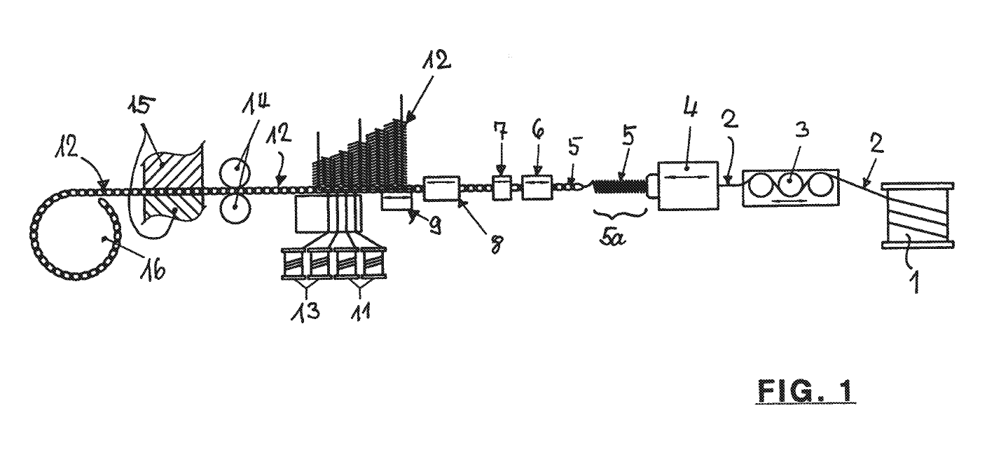

In the following an embodiment example of the subject matter of the invention and its operational function and additional advantages will be explained in further detail in conjunction with FIGS. 1 to 7.

In the drawing depict:

FIG. 1 a highly schematic side view of the essential arrangement components,

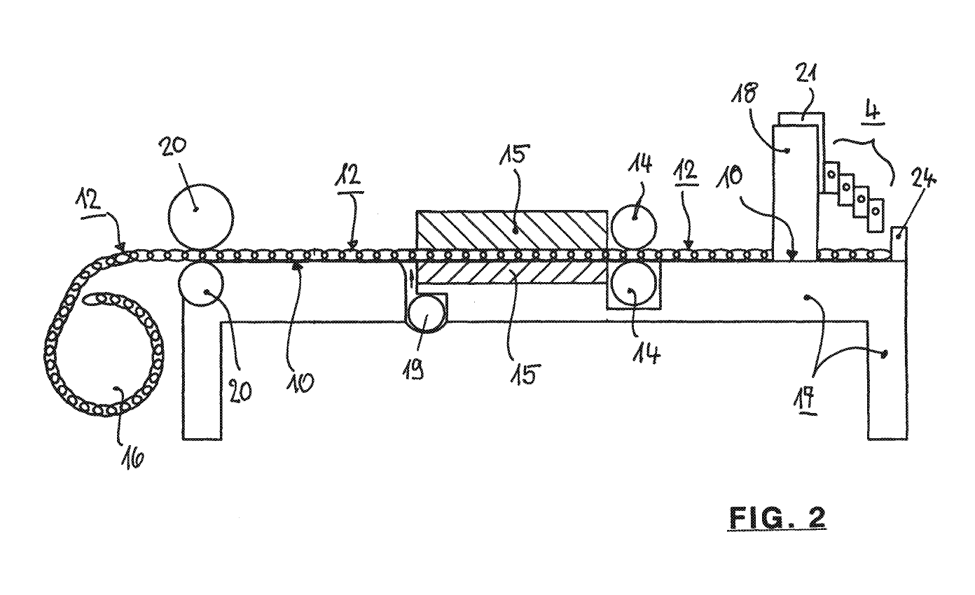

FIG. 2 a detail from FIG. 1 at an enlarged scale,

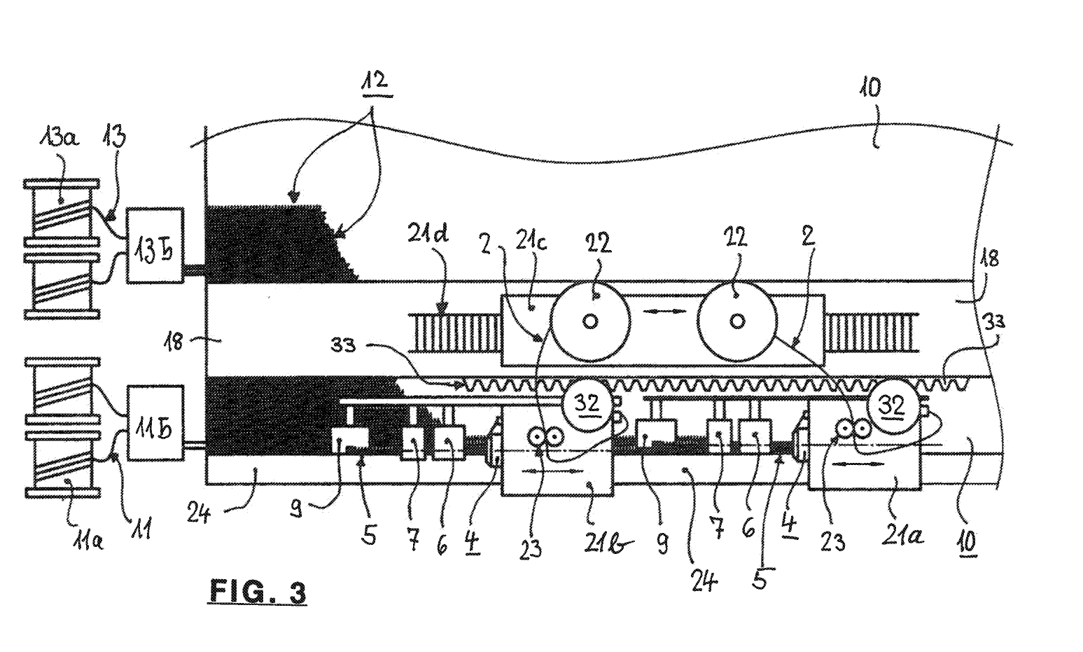

FIG. 3 a top view onto the right portion of FIG. 2, again at an enlarged scale,

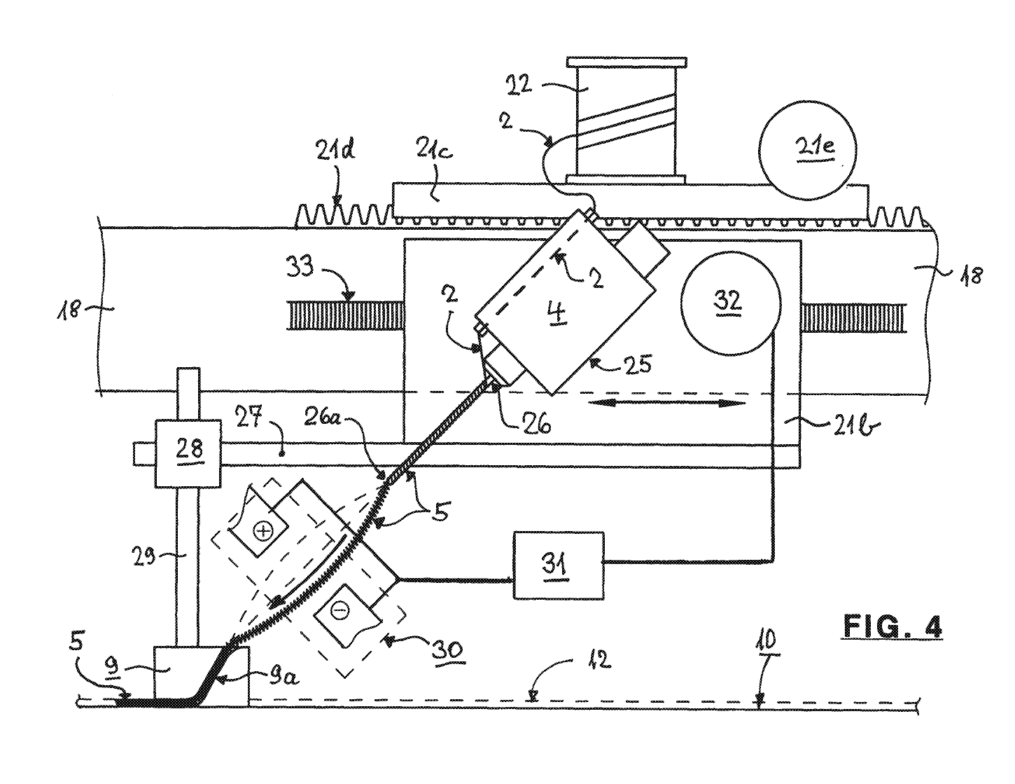

FIG. 4 a side view of a winding device with connected joining device,

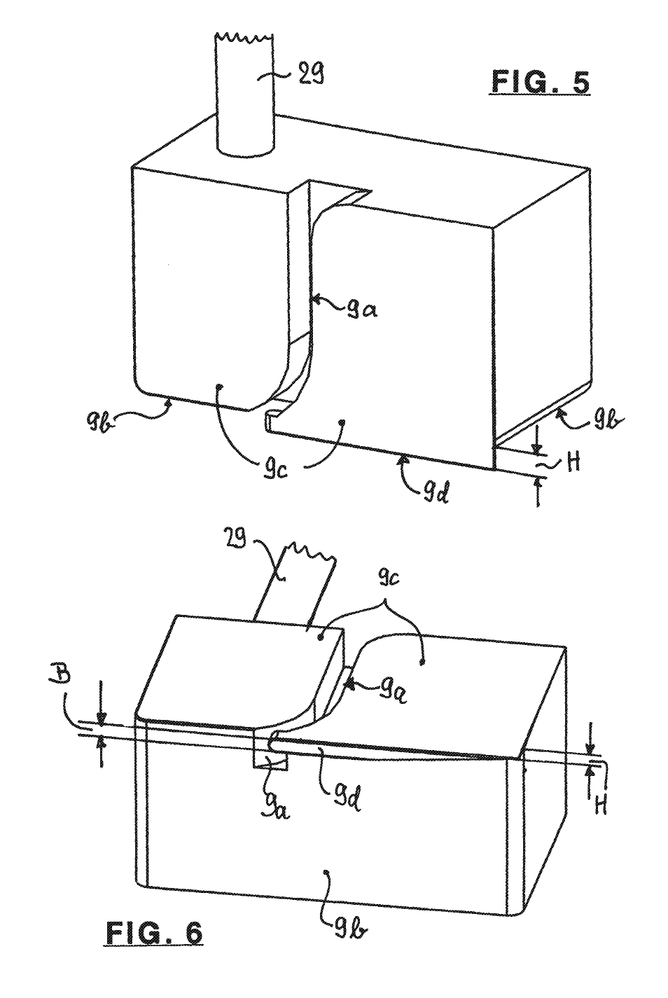

FIG. 5 a perspective side view of a joining device,

FIG. 6 a perspective view from below of the joining device according to FIG. 5, and

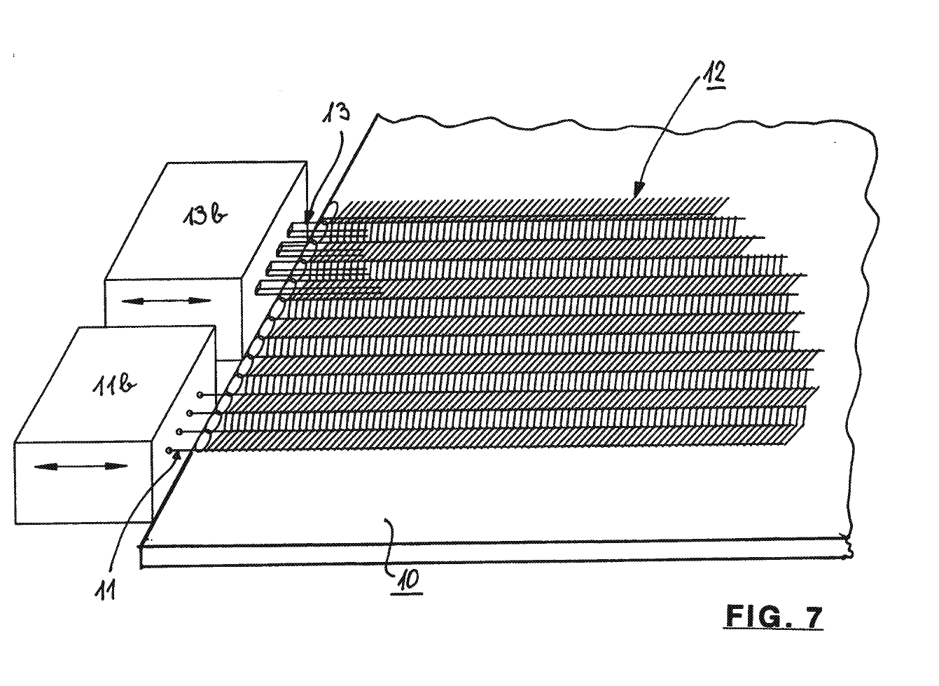

FIG. 7 a perspective view of a deposited coil screen in cooperation with one slide-in device each for fixing wires and [coil] filler wires.

In FIG. 1 on the right-hand side is depicted a supply drum 1 with a monofilament wire 2 of a thermoplastic synthetic material, which [wire] is supplied to a braking device 3 with brake cylinders, which are decelerated by an hysteresis effect known per se, Succeeding thereto the wire 2 is supplied to a winding device 4 which generates a precisely defined coil 5 from the wire 2. In the coil segment 5a is located a forming body 26 (see FIG. 4) which tapers in the draw-off direction of the coil 5 such that the coil 5 can lift off at its circumference.

The coil 5 passes successively through a precisely temperature-controlled heating chamber 6 in which the coil 5 is transformed into a stress-free state through a hot air stream directed transversely thereto. Through a succeeding cooling channel 7 the geometry of the coil 5 is lastly set (oval, racetrack-shaped and the like). The cooling channel 7 is again succeeded by a sensor device 8 for acquiring and regulating the path course of the coil 5 before it enters into the joining device 9, the cooperation of which with the winding device 4 will be explained in further detail in conjunction with FIGS. 4 to 6.

Through the joining device 9 individual coil segments are so deposited on a working surface 10 shown in FIG. 2 that the individual windings engage into one another and overlap so far that fixing wires 11 can be slid into the particular overlap region (see FIG. 7). For better understanding here a segment of a coil screen 12 is depicted perpendicularly to the working surface 10. The coil screen lies in reality flat on the working surface 10, e.g., perpendicularly to the plane of drawing according to FIGS. 1 and 2. Following the fixing wires 11, parallel hereto filler wires 13 can additionally also be slid into the coil screen 12, which is depicted in further detail in FIGS. 3 and 7.

The coil screen 12 subsequently passes with regulated speed through transport cylinders 14, which are succeeded by a heating apparatus 15 with planar contact faces for the coil screen 12 through which the coil screen 12 is brought to uniform thickness and is herein smoothed. The coil screen 12 is lastly wound onto a draw-off cylinder 16.

According to FIG. 2 the working surface 10 is a planar surface of a machine frame 17 from which projects a gateway guide frame 18 on which are disposed a total of four winding devices 4 spatially offset, which is here only indicated and will be explained in further detail in conjunction with FIGS. 3 and 4. Succeeding these winding devices in the direction of transport of the coil screen 12 are again the transport cylinders 14 and the heating apparatus 15 for smoothing the coil screen 12, which is succeeded by a cooling device 19 for the setting. A draw-off of the coil screen 12 again under regulation takes place with the support by the cylinder pair 20.

Utilizing the same reference numbers as before, FIGS. 3 and 4 show again the working surface 10 with the guide frame 18. On this [frame] are disposed two separate carriages 21a and 21b, each of which bears a winding device 4 and the associated heating chamber 6, the cooling channel 7 and the joining device 9. On the guide frame 18 is located a further carriage 21c with two supply drums 22 each with a monofilament wire 2 which is supplied via one braking device 23 each to the associated winding device 4. The carriage 21c is driven by a gearing motor 21e with a (not shown) pinion, which engages into a toothed rack 21d. The carriage 21c is guided such that it tracks the carriages 21a and 21b. The joining devices 9 will be explained in further detail in conjunction with FIGS. 4 to 6.

As depicted here, the winding devices 4 are disposed such that in the direction of transport of the coil screen 12 they are offset by a measure which corresponds to the spacing of two coils 5 interlaced into one another. Transversely to this transport direction the winding devices 4 are disposed offset by such measure that between two winding devices 4 each the heating chambers 6, the cooling channels 7 and the joining device 9 can be accommodated. Supply rollers 11a and 13a for fixing wires 11 and filler wires 13 and the associated slide-in apparatus 11b and 13b are also disposed sequentially one after the other in the transport direction of the coil screen 12.

The movement directions of the carriages 21a and 21b along the guide frame 18 occur parallel to a guide rail 24 disposed on the working surface 10 and which is critical for the joining process of the individual coils 5, which will still be described in further detail in the following.

Carrying forward the previous reference numbers, FIG. 4 shows further details as follows: the carriage 21b, here shown exclusively, bears the winding device 4. This [device] includes within a motor housing 25 a rotor, not further emphasized here, with an eccentric guide channel through which the wire 2 is guided. Projecting from the motor housing 25 is a non-rotating forming body 26, onto which the wire 2 is continuously wound by means of the rotating guide channel and which in top view (from above left) has the shape of a blade [contour] which transitions from a more strongly convergent neck portion into a more weakly convergent end portion. The coil 5 thereby receives the requisite degree of freedom for drawing off or sliding off from the forming body 26 at its end 26a. The axes of the motor and of the forming body 26 extend, for example, at a 45 degree angle to the working surface 10. The heating chamber 6 and the cooling channel 7 encompassing the forming body 26 with the coil 5 are omitted here for the sake of clarity. On the carriage 21b is also secured the joining device 9 via a cantilever beam 27 and a cross piece 28, the underside of which joining device is displaceable on the working surface 10 parallel to the guide rail 24 (FIG. 3). The height adjustment takes place via a holding pin 29. The joining device 9 includes a guide channel 9a for the coil 5 now set.

Between the end 26a and the above located entrance of the guide channel 9a for the coil 5 is formed under optimal operating conditions a minimally downwardly curved path course which is critical for the winding spacing of the coil 5 and which is to be kept constant. For this purpose in the free path course of the coil 5 a sensor device 30 is disposed whose measuring signals are supplied to a regulation system 31. This [system] subsequently controls, in turn, a driving motor 32 located on carriage 21b, which [motor] engages with a pinion into a toothed rack 33 on the guide frame 18.

An essential element of the invention is the joining device 9, such as is depicted in FIGS. 5 and 6. In addition to the S-shaped curved guide channel 9a, this [device] includes an underside 9b extending in the installed state parallel to the working surface 10, and a side face 9c which, in the installed state, is movable along the guide rail 24. Beyond the underside 9b projects a wedge-shaped guide profile 9d, whose height H corresponds to the height of a coil 5 and whose width B corresponds to the dimensional difference between the width of a first coil 5 minus the width dimension of a second coil 5 slid into this [coil]. It follows therefrom that a coil 5 already deposited on the working surface 10 during the moving-over by the joining device 9 with emplaced succeeding coil 5 is displaced on the working surface 10 transversely to the guide rail 24 precisely by such measure that the desired overlap of two adjacent coils 5 permits sliding in or injecting a fixing wire 11. It is evident that the guide channel 9a is open toward the side face 9c such that the newly supplied coil 5 is also guided through the guide rail 24.

In agreement to a large extent with FIG. 3, FIG. 7 shows a larger areal portion of a coil screen 12 which can have a width of 6 meters and more, in front of a slide-in apparatus 11b for a group of fixing wires 11 and an optionally insertable slide-in apparatus 13b for sliding in so-called filler wires 13 which, as a rule, have a rectangular cross section. FIG. 7 also shows that the coils 5 are realized with opposite winding direction (left-hand/right-hand), however, such is not mandatory.

The changing movement of such groups of winding device(s) 4 and joining device(s) 9, such as are shown in FIGS. 3 to 6, takes place, with reference to FIG. 7, through periodic control reversal in the proximity of the front margin, thus at the start of the coil screen 12, in the sense of the arrows in FIGS. 3 and 4. During the rearward movement the carriages 21a and 21b with their build-outs are lifted by a minimal degree of a few millimeters, preferably by approximately 2 mm, with respect to the forward movement.

Further preferred embodiments of the invention will be specified as follows:

As the raw material for the wires or monofilaments, synthetic materials from the group of polyester, Ryton, PEEK, polyamide, PPS and the like are utilized. The winding device, preferably implemented as a winding head, includes an infeed brake preferably implemented as a hysteresis brake, which is electrically regulatable. It is succeeded by a shaping means for deforming round monofilaments into flat wires. The described air contact heating is preferably provided with an electronic regulation to reach and maintain a material-dependent temperature with a maximal fluctuation amplitude of ∀0.5 EC of the particular required setting temperature.

Cutting apparatus for cutting the separate spirals and the coil screens can also be provided as well as draw-off and wind-up apparatus. The fixing wire slide-in apparatus can be provided with setting and centering apparatus as well as with advancing means for the precise positioning of the fixing wire during the joining process. The same applies to an optionally provided injection arrangement for filler wires. Associated with the preferably heatable working surface as the surface of a work bench can be a smoothing arrangement and/or a setting means for the fixing wires. Especially preferred is a complete control or regulation with a PC and a program for the control or regulation of all interface linkages.

### LIST OF REFERENCE SYMBOLS

1 Supply drum
2 Wire
3 Braking device
4 Winding device
5 Coil
5a Coil segment
6 Heating chamber
7 Cooling channel
8 Sensor device
9 Joining device
9a Guide channel
9b Underside
9c Side face
9d Guide profile
10 Working surface
11 Fixing wires
11a Supply rollers
11b Slide-in apparatus
12 Coil screen
13 Filler wires
13a Supply rollers
13b Slide-in apparatus
14 Transport cylinders
15 Heating apparatus
16 Draw-off cylinder
17 Machine frame
18 Guide frame
19 Cooling device
20 Cylinder pair
21a Carriage
21b Carriage
21c Carriage
21d Toothed rack
21e Gearing motor
22 Supply drums
23 Braking device
24 Guide rail
25 Motor housing
26 Forming body
26a End
27 Cantilever beam
28 Cross piece
29 Holding pin
30 Sensor device
31 Regulation system
32 Driving motor
33 Toothed rack
H Height
B Width

1. A method for the production of coil screens comprising winding wires of synthetic materials into individual coils which are slid one into the other on a working surface in the transverse direction such that they overlap and, using fixing wires, are combined parallel to one another into porous areal formations, wherein the coils after the winding are deposited one next to the other on the working surface and on this working surface are brought into engagement by a joining device and are connected with one another using the fixing wires, wherein
a) the coils are generated through the at least one winding device above the working surface and, after thermal forming operation, through a movement of the joining device are deposited next to a guide rail on the working surface,
b) the particular succeeding coils through a movement of their winding device and the joining device succeeding thereto, are deposited between the guide rail and the previously deposited coils on the working surface, wherein the at least one previously deposited coil through the movement of the joining device transversely thereto is displaced by a measure of the overlap on the working surface, and wherein
c) the particular last deposited coils are connected with one another through at least one inserted fixing wire.

2. A method as claimed in claim 1, wherein the particular coil is guided through an S-shaped guide channel through the joining device, whose upper end is oriented toward the winding device and whose lower end is oriented in the shape of an arc toward the working surface.

3. A method as claimed in claim 1, wherein over the same working surface are moved spatially offset several winding devices with joining devices.

4. A method as claimed in claim 1, wherein in addition to the fixing wires, filler wires are slid into the already combined coils.

5. A method as claimed in claim 1, wherein the coils are produced by winding wires onto forming bodies whose cross section in the direction of transport of the coils decreases and that the forming body is guided through a hot air stream in which the coiled wire is transformed into a stress-free state.

6. A method as claimed in claim 5, wherein following the hot air treatment, the coil is cooled to a temperature below the softening temperature.

7. A method as claimed in claim 1, wherein the path course of the coils between winding device and joining device is acquired through a sensor device, and that discrepancies from a predetermined path course are transmitted to a driving motor such that the movement rate of the winding device and of the joining device over the working surface is adapted to the joining process.

8. A method as claimed in claim 1, wherein the areal formation on the working surface is smoothed during the passage through a heating apparatus and brought to a predetermined thickness and set by cooling.

9. An arrangement for the production of coil screens with at least one winding device through which wires of synthetic material are formable into individual coils, with a working surface on which the coils can be deposited, and with at least one joining device through which the coils can be slid into one another in the transverse direction and, using fixing wires, can be combined parallel to one another into porous areal formations, wherein
a) the joining device is disposed above the working surface such that it is displaceable,
b) the at least one winding device is so disposed above the working surface that the coils after the winding can be deposited one next to the other on the working surface and on this working surface after their transverse displacement through the joining device can be connected with one another using the fixing wires.

10. An arrangement as claimed in claim 9, wherein
a) above a working surface at least one winding device for the coils and on the working surface a guide rail for the deposition and orientation of the coils are disposed,
b) the joining device succeeds the winding device such that through the joining device between the guide rail and the previously deposited coil a further coil can be deposited on the working surface, and that
c) associated with the working surface is a slide-in device for the insertion of a fixing wire into each of the two last deposited coils.

11. An arrangement as claimed in claim 10, wherein the joining device includes an S-shaped guide channel whose upper end is oriented toward the winding device and whose lower end is oriented toward the working surface in the form of an arc.

12. An arrangement as claimed in claim 9, wherein associated with the working surface is a slide-in device for the insertion of a filler wire into at least one of the coils.

13. An arrangement as claimed in claim 9, wherein spatially offset several winding devices with joining devices are disposed such that they are displaceable over the same working surface.

14. An arrangement as claimed in claim 9, wherein for the production of the coils by winding wires, forming bodies are provided whose cross section in the direction of transport of the coils decreases, and that the forming body is encompassed by a heating chamber through which a hot air stream can be conducted.

15. An arrangement as claimed in claim 10, wherein the joining device succeeds the winding device, wherein
a) the joining device is displaceable along the guide rail,
b) the joining device includes an underside and at least one side face in which is disposed a guide channel for the coils, through which the coil can be guided under the underside and wherein
c) beneath the underside a guide profile of such height is disposed which corresponds to the height dimension H of the coil, wherein the guide profile is implemented in the form of a wedge such that the particular previously deposited coil(s) is displaceable so far in the transverse direction away from the guide rail that the newly supplied coil can be brought into overlapping engagement with the previously deposited coil.

16. An arrangement as claimed in claim 15, wherein the underside of the guide body extends parallel to the working surface and said side face extends parallel to the guide rail.

17. An arrangement as claimed in claim 13, wherein the axes of winding device and forming body for the formation and the draw-off of the coils are oriented in the direction toward the joining device at an acute angle (∀) between 15 and 60 degrees to the working surface.

18. An arrangement as claimed in claim 9, wherein the winding device is preceded by a braking device for the supplied wire.

19. An arrangement as claimed in claim 10, wherein for the acquisition of the path course of the coil between the winding device and the joining device a sensor device is disposed through which discrepancies from a predetermined path course can be acquired and can be transmitted to a driving motor such that the movement rate of the winding device and of the joining device over the working surface can be adapted to the joining process.

20. An arrangement as claimed in claim 9, wherein on the working surface heating apparatus is disposed through which the areal formation can be smoothed during the passage and can be brought to a predeterminable thickness.

21. An arrangement as claimed in claim 9, wherein in the presence of several winding devices these are disposed on separate carriages, which, independently of one another, are disposed on a guide frame above the working surface and through one sensor device each for the path course of the coil, a regulation system and the associated driving motor are displaceable over the working surface.

22. An arrangement as claimed in claim 21, wherein the driving motors for the moving of the winding devices are connected via pinions with a common toothed rack, which is disposed on the guide frame.

23. An arrangement as claimed in claim 21, wherein associated with the winding devices is a further carriage, which is connected via a gearing motor and a pinion with a further toothed rack, which is also disposed on the guide frame, and that the carriage bears at least one supply drum for the wire to be coiled.

24. An arrangement as claimed in claim 23, wherein the carriage with the at least one supply drum under regulation can track at a spacing the at least one associated winding device.
